(19) United States
(12) Patent Application Publication
(10) Pub. No.: US 2025/0078535 A1
(43) Pub. Date: Mar. 6, 2025

(54) LEARNING DEVICE, LEARNING METHOD, AND STORAGE MEDIUM

(71) Applicants: HONDA MOTOR CO., LTD., Tokyo (JP); SENSETIME GROUP LIMITED, Shatin, N.T.Hong Kong (CN)

(72) Inventors: Akira Kanehara, Wako-shi (JP); Chenguang Li, Shanghai (CN); Jiazhao Zhang, Shanghai (CN)

(21) Appl. No.: 18/815,880

(22) Filed: Aug. 27, 2024

(30) Foreign Application Priority Data
Aug. 28, 2023 (CN) 202311092598.7

(51) Int. Cl. G06V 20/56; G06N 20/00; G06V 10/778; G06V 10/82

(52) U.S. Cl. CPC G06V 20/588; G06N 20/00; G06V 10/778; G06V 10/82

(57) ABSTRACT

A learning device that learns a machine learning model that uses an image including a plurality of pixels as an input and outputs a determination value indicating whether or not each of the pixels represents a road, including: a storage medium that stores a computer-readable command; and a processor that is connected to the storage medium, the processor executing the computer-readable command to set a weight for an error between the determination value output by the machine learning model and learning data indicating whether or not each of the pixels represents a road and learn the machine learning model to reduce a value of a loss function calculated on the basis of the error for which the weight has been set, the processor increasing the weight in one or more predetermined directions from a lower end center of the image.

### CROSS-REFERENCE TO RELATED APPLICATION

Priority is claimed on Chinese Patent Application No. 202311092598.7, filed Aug. 28, 2023, the content of which is incorporated herein by reference.

### BACKGROUND

### Field of the Invention

The present invention relates to a learning device, a learning method, and a storage medium.

### Description of Related Art

In the related art, a technology of detecting a road region included in an image for utilization in a vehicle driving assistance or automatic driving is known. For example, Japanese Unexamined Patent Application, First Publication No. 2020-038101 discloses a technology of scanning an input image in an x direction, extracting edges, detecting white lines on the basis of color differences near the edges, and thereby detecting a road region.

However, according to the technology described in Japanese Unexamined Patent Application, First Publication No. 2020-038101, the accuracy of scanning may deteriorate due to a decrease in number of pixels as a location of the region included in the image becomes further away. In this manner, it may not be possible to accurately detect a road region from a far region in the region included in the image according to the technology in the related art.

### SUMMARY

The present invention was made in consideration of such circumstances, and an object thereof is to provide a learning device, a learning method, and a storage medium capable of generating a machine learning model that accurately detects a road region from a far region in a region included in an image.

The learning device, the learning method, and the storage medium according to the present invention employ the following configurations.

(1): A learning device according to an aspect of the present invention is a learning device that learns a machine learning model that uses an image including a plurality of pixels as an input and outputs a determination value indicating whether or not each of the pixels represents a road, the learning device including: a storage medium that stores a computer-readable command; and a processor that is connected to the storage medium, in which the processor executes the computer readable command to set a weight for an error between the determination value output by the machine learning model and learning data indicating whether or not each of the pixels represents a road, and learn the machine learning model to reduce a value of a loss function calculated on the basis of the error for which the weight has been set, and the processor increases the weight in one or more predetermined directions from a lower end center of the image.

(2): In the aspect (1) above, the processor increases the weight toward an upper end and left and right ends from the lower end center of the image as the one or more predetermined directions.

(3): A learning method according to another aspect of the present invention is a learning method of learning a machine learning model that uses an image including a plurality of pixels as an input and outputs a determination value indicating whether or not each of the pixels represents a road, the method including, by a computer: setting a weight for an error between the determination value output by the machine learning model and learning data indicating whether or not each of the pixels represents a road; and learning the machine learning model to reduce a value of a loss function calculated on the basis of the error for which the weight has been set, in which in the setting, the weight is increased in one or more predetermined directions from a lower end center of the image.

(4): A computer-readable non-transitory storage medium according to another aspect of the present invention is a computer-readable non-transitory storage medium that stores a program causing a machine learning model that uses an image including a plurality of pixels as an input and outputs a determination value indicating whether or not each of the pixels represents a road to be learned, the program causing a computer to: set a weight for an error between the determination value output by the machine learning model and learning data indicating whether or not each of the pixels represents a road; and learn the machine learning model to reduce a value of a loss function calculated on the basis of the error for which the weight has been set, in which in the setting, the weight is increased in one or more predetermined directions from a lower end center of the image.

According to (1) to (4), it is possible to generate a machine learning model that accurately detects a road region from a far region in a region included in an image.

### BRIEF DESCRIPTION OF THE DRAWINGS

FIG. 1 is a diagram illustrating a configuration of a learning device according to an embodiment.

FIG. 2 is a diagram illustrating an example of a configuration of learning data.

FIG. 3 is a diagram for explaining a method by which a setting unit sets a weight.

FIG. 4 is a flowchart illustrating an example of a flow of processing executed by the learning device according to the present embodiment.

### DESCRIPTION OF EMBODIMENTS

Hereinafter, an embodiment of a learning device, a learning method, and a storage medium according to the present invention will be described with reference to the drawings.

### [Configuration]

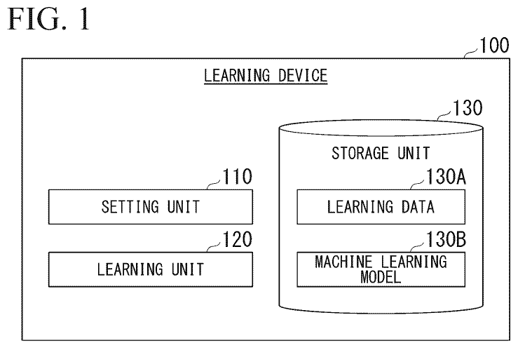

FIG. 1 is a diagram illustrating a configuration of a learning device 100 according to the present embodiment. The learning device 100 is an information processing device that learns a machine learning model that uses an image including a plurality of pixels as an input and outputs a determination value indicating whether or not each of the pixels represents a road. The learning device 100 includes, for example, a setting unit 110, a learning unit 120, and a storage unit 130. Each of the setting unit 110 and the learning unit 120 is realized by a hardware processor such as a central processing unit (CPU), for example, executing a program (software). Also, some or all of these components may be realized by hardware (circuit unit: including circuitry) such as a large scale integration (LSI), an application specific integrated circuit (ASIC), a field-programmable gate array (FPGA), or a graphics processing unit (GPU) or may be realized through corporation of software and hardware. The program may be stored in advance in a storage device (a storage device including a non-transitory storage medium) such as an HDD or a flash memory of an automatic driving control device 100, or may be stored in a detachable storage medium such as a DVD or a CD-ROM, and may be installed onto the HDD or the flash memory of the automatic driving control device 100 by the storage medium (non-transitory storage medium) being attached to a drive device. The storage unit 130 stores, for example, learning data 130A and a machine learning model 130B. The storage unit 130 is realized by, for example, a RAM, a flash memory, or an SD card.

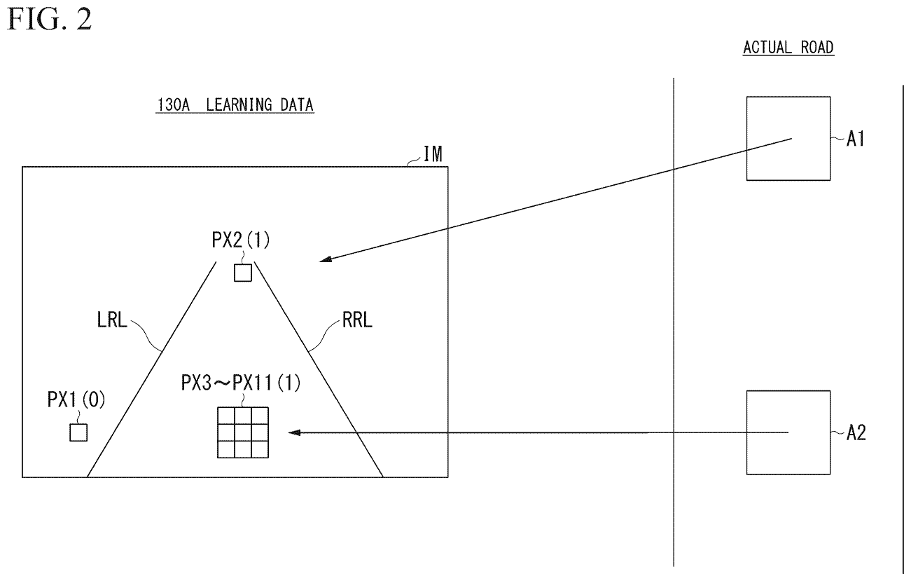

FIG. 2 is a diagram illustrating an example of a configuration of the learning data 130A. In the learning data 130A, label values indicating whether or not pixels represent a road are associated with one or more pixels PX (pixel group) of an image IM, for example. In the case of FIG. 2, for example, a region sandwiched between a road marking lines LRL and RRL represents a road region, a label value 0 indicating that the pixel does not represent a road is associated with a pixel PX1, while a label value 1 indicating that the pixels represent a road is associated with pixels PX2 to PX11. The learning data 130A is generated by an administrator or an operator of the learning device 100 designating each pixel in the image IM and a label value in advance on a terminal of the administrator or the operator and is stored in the storage unit 130. Alternatively, the learning device 100 may download the learning data 130A stored in an external server onto the storage unit 130 via a network at a timing at which the learning unit 120 executes learning. The label value is an example of the “determination value” in the claims.

The machine learning model 130B is a machine learning model that uses the image IM as an input and outputs a label value indicating whether or not each pixel in the image IM represents a road. The machine learning model 130B is a convolution neural network (CNN), for example, and outputs a label value indicating whether or not each pixel represents a road by extracting a feature amount of the pixel (pixel groups) in the input image IM. Note that the image IM to be input to the machine learning model 130B may be a raw image captured by a camera mounted in a vehicle or may be a planar projection image or a cylindrical projection image of a road obtained by converting the raw image.

Here, the machine learning model is typically learned to reduce a value of a loss function calculated on the basis of an error between the label value output by the machine learning model and the learning data 130A indicating whether or not each pixel represents a road, and a final learned model is thereby generated in the technology in the related art. Here, the loss function is defined as an absolute sum of the error for each pixel, for example. On the other hand, a region of the same area is expressed by a small number of pixels at a location further from a point where the image IM is captured. As illustrated in the right part in FIG. 2, for example, although regions A1 and A2 have the same area on the real road, the region A1 that is further from the point of imaging is represented by a single pixel PX2, while the region A2 that is closer to the point of imaging is expressed by a plurality of pixels PX3 to PX11. As a result, the learned model generated by the technology in the related art tends to have high output accuracy in a region closer to the point of imaging and have low output accuracy in a region further from the point of imaging.

From the background of such circumstances, the setting unit 110 sets (multiplies, for example) a weight for the error between the label value output by the machine learning model 130B and the learning data 130A indicating whether or not each pixel represents a road. More specifically, the setting unit 110 increases the value of the weight to be set for the error in one or more predetermined directions from a lower end center of the image IM. In other words, the setting unit 110 can prevent accuracy of machine learning for the further region from being degraded by increasing the value of the error related to the region that is further from the point of imaging with the weight as compared with the error related to the region that is closer to the point of imaging.

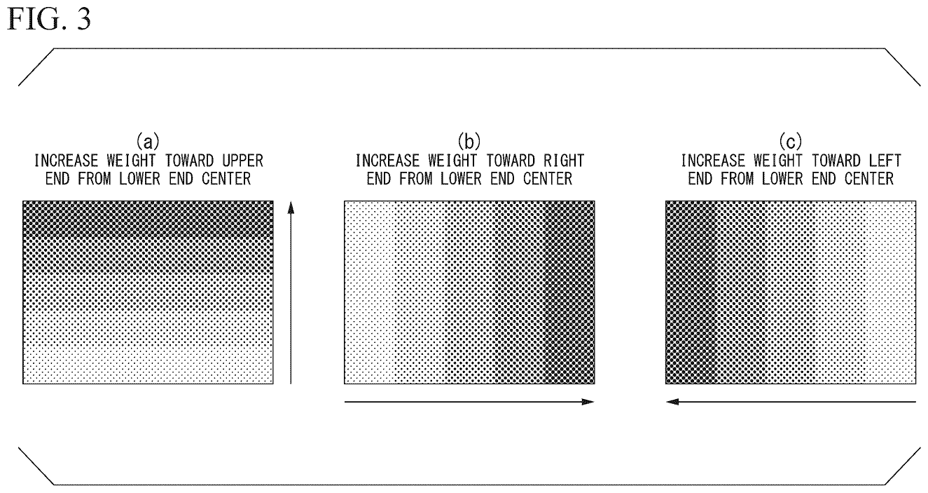

FIG. 3 is a diagram for explaining a method by which the setting unit 110 sets the weight. The setting unit 110 increases the weight toward an upper end and left and right ends from the lower end center of the image IM as the one or more predetermined directions. For example, the setting unit 110 may increase the value of the weight to be set for the error toward the upper end from the lower end center of the image IM as illustrated in the pattern in FIG. 3 (a), the setting unit 110 may increase the value of the weight to be set for the error toward the right end from the lower end center of the image IM as illustrated in the pattern in FIG. 3 (b), or the setting unit 110 may increase the value of the weight to be set for the error toward the left end from the lower end center of the image IM as illustrated in the pattern in FIG. 3(c). These patterns may be applied at the same time (in a case where a pixel is located to an upper left in the image IM, for example, both the weight of the pattern in FIG. 3(a) and the weight of the pattern in FIG. 3(c) may be set), or only a specific pattern may be selected and applied from among these patterns. In the present embodiment, the setting unit 110 is assumed to increase the value of the weight to be set for the error at least toward the upper end from the lower end center of the image IM.

The learning unit 120 learns the machine learning model 130B to reduce the value of the loss function (an absolute sum of errors, for example) on the basis of the error for which the weight has been set after the setting unit 110 sets the weight for the error between the label value output by the machine learning model 130B and the learning data 130A indicating whether or not each of the pixels in the image IM represents a road. For the learning in this case, an arbitrary learning method such as back propagation, for example, may be used. The learning unit 120 acquires the machine learning model 130B for which learning has been completed as a learned model.

The acquired learned model may be used by a driving assistance device or a vehicle control device mounted in the vehicle. For example, the driving assistance device may input a vehicle front image captured by the camera to the learned model and display a road region output by the learned model on an HMI. For example, the vehicle control device may input a vehicle front image captured by the camera to the learned model and control the vehicle to travel within the road region output by the learned model.

As described above, the setting unit 110 increases the value of the weight to be set for the error in the one or more predetermined directions from the lower end center of the image IM, and the learning unit 120 learns the machine learning model 130B to reduce the value of the loss function on the basis of the error for which the weight has been set in the present embodiment. It is thus possible to generate a machine learning model that accurately detects the road region from a far region from among the regions included in the image.

### [Flow of Processing]

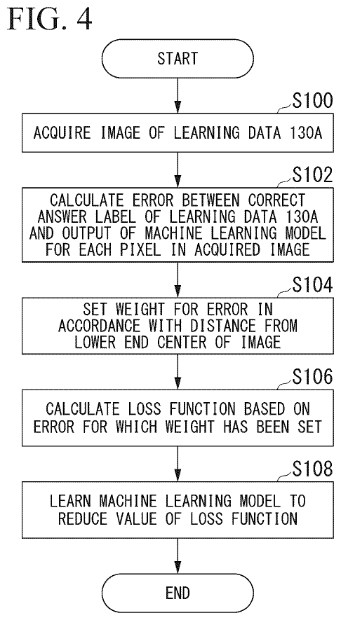

Next, a flow of processing executed by the learning device 100 according to the present embodiment will be described with reference to FIG. 4. FIG. 4 is a flowchart illustrating an example of a flow of processing executed by the learning device 100 according to the present embodiment.

First, the learning unit 120 acquires an image from the learning data 130A stored in the storage unit 130 (Step S100). Then, the learning unit 120 calculates an error between a correct answer label of the learning data 130A and an output of the machine learning model 130B for each pixel in the acquired image (Step S102).

Next, the setting unit 110 sets a weight for the error calculated by the learning unit 120 in accordance with a distance from the lower end center of the image (Step S104). Then, the learning unit 120 calculates a loss function on the basis of the error for which the weight has been set (Step S106). Then, the learning unit 120 learns the machine learning model 130B to reduce the value of the calculated loss function (Step S108). In this manner, the processing according to the flowchart ends.

As described above, the weight is set for the error between the determination value output by the machine learning model that uses the image including the plurality of pixels as an input and outputs the determination value indicating whether or not each of the pixels represents a road and the learning data indicating whether or not each pixel represents a road, the machine learning model is learned to reduce the value of the loss function calculated on the basis of the error for which the weight has been set, and in the setting, the weight is increased in the one or more predetermined directions from the lower end center of the image. It is thus possible to generate the machine learning model that accurately detects the road region from the far region in the region included in the image.

The embodiment described hitherto can be expressed as follows.

A learning device including: a storage medium that stores a computer-readable command; and a processor that is connected to the storage medium, in which the at least one processor executes the computer-readable command to set a weight for an error between a determination value output by a machine learning model that uses an image including a plurality of pixels as an input and outputs a determination value indicating whether or not each of the pixels represents a road and learning data indicating whether or not each of the pixels represents a road and learn the machine learning model to reduce a value of a loss function calculated on the basis of the error for which the weight has been set, and in the setting, the weight is increased in one or more predetermined directions from a lower end center of the image.

Although the above description has been given using the embodiment of a mode for carrying out the invention, the present invention is not limited to such an embodiment in any sense, and various modifications and replacements can be added without departing from the gist of the present invention.

What is claimed is:

1. A learning device that learns a machine learning model that uses an image including a plurality of pixels as an input and outputs a determination value indicating whether or not each of the pixels represents a road, the learning device comprising:
a storage medium that stores a computer-readable command; and
a processor that is connected to the storage medium,
wherein the processor executes the computer readable command to
set a weight for an error between the determination value output by the machine learning model and learning data indicating whether or not each of the pixels represents a road, and
learn the machine learning model to reduce a value of a loss function calculated on the basis of the error for which the weight has been set, and
the processor increases the weight in one or more predetermined directions from a lower end center of the image.

2. The learning device according to claim 1, wherein the processor increases the weight toward an upper end and left and right ends from the lower end center of the image as the one or more predetermined directions.

3. The learning device according to claim 1, wherein the processor increases the weight toward an upper end from the lower end center of the image as the one or more predetermined directions.

4. A learning method of learning a machine learning model that uses an image including a plurality of pixels as an input and outputs a determination value indicating whether or not each of the pixels represents a road, the method comprising, by a computer:
setting a weight for an error between the determination value output by the machine learning model and learning data indicating whether or not each of the pixels represents a road; and
learning the machine learning model to reduce a value of a loss function calculated on the basis of the error for which the weight has been set,
wherein in the setting, the weight is increased in one or more predetermined directions from a lower end center of the image.

5. A computer-readable non-transitory storage medium that stores a program causing a machine learning model that uses an image including a plurality of pixels as an input and outputs a determination value indicating whether or not each of the pixels represents a road to be learned, the program causes a computer to:
set a weight for an error between the determination value output by the machine learning model and learning data indicating whether or not each of the pixels represents a road; and
learn the machine learning model to reduce a value of a loss function calculated on the basis of the error for which the weight has been set,
wherein in the setting, the weight is increased in one or more predetermined directions from a lower end center of the image.
